(19) United States
(12) Patent Application Publication
(10) Pub. No.: US 2014/0379406 A1
(43) Pub. Date: Dec. 25, 2014

(54) RESERVED SERVICE ALARM METHOD AND TERMINAL THEREFOR

(71) Applicant: Samsung Electronics Co., Ltd., Suwon-si (KR)

(72) Inventors: Wondo KANG, Seongnam-si (KR); Jiyeon JUNG, Suwon-si (KR)

(21) Appl. No.: 14/294,598

(22) Filed: Jun. 3, 2014

(30) Foreign Application Priority Data
Jun. 25, 2013 (KR) 10-2013-0073135

(51) Int. Cl. G06Q 10/10

(52) U.S. Cl. CPC G06Q 10/1095
USPC 705/7.19

(57) ABSTRACT

An alarm method of a terminal for alarming upcoming service time configured based on a reserved service start time extracted from the purchased service information is provided. The service alarm provision method of the terminal includes receiving service information provided by a store management system, configuring alarm execution information based on time information included in the service information, and executing an alarm when an alarm time indicated in the alarm execution information arrives.

### CROSS-REFERENCE TO RELATED APPLICATION(S)

This application claims the benefit under 35 U.S.C. §119(a) of a Korean patent application filed on Jun. 25, 2013 in the Korean Intellectual Property Office and assigned Serial number 10-2013-0073135, the entire disclosure of which is hereby incorporated by reference.

### TECHNICAL FIELD

The present disclosure relates to a service alarm provision method and a terminal therefor. More particularly, the present disclosure relates to a service alarm provision method of a terminal for extracting service start time information from reserved service information and for configuring an alarm based on the service start time information.

### BACKGROUND

Recently, with the economy continuing to flourish, various types of service demands are emerging in various fields and the service categories are subdivided more and more to meet the demands of the customers. Unlike normal services which are provided immediately upon payment, a certain service requiring reservation, such as cultural performance, is provided when the reserved time arrives.

Typically, if the reserved service time arrives after the payment, the service provider issues a bill or a ticket to the service user to provide the information on the purchased service. The user has to memorize the information on the service by referencing the issued bill or ticket to not miss the purchased service, but there is risk of oblivion.

Therefore, a need exists for a service alarm provision method of a terminal for extracting service start time information from reserved service information and for configuring an alarm based on the service start time information.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for providing an alarm when a reserved service time arrives.

In accordance with an aspect of the present disclosure, a service alarm provision method of a terminal is provided. The service alarm provision method includes receiving service information provided by a store management system, configuring alarm execution information based on time information included in the service information, and executing an alarm when an alarm time indicated in the alarm execution information arrives.

In accordance with another aspect of the present disclosure, a terminal is provided. The terminal includes a communication unit configured to receive service information from a store management system, a storage unit configured to store alarm execution information, a control unit configured to configure alarm execution information based on time information included in the service information and to execute the alarm when an alarm time indicated in the alarm execution information arrives, and an alarm unit configured to execute the alarm under the control of the control unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is diagram illustrating service information transfer from a store management system to a terminal according to an embodiment of the present disclosure;

FIG. 2 is a block diagram illustrating a configuration of a terminal according to an embodiment of the present disclosure;

FIG. 3 is a diagram illustrating an alarm configuration information table stored in an alarm setting information storage according to an embodiment of the present disclosure;

FIG. 4 is a flowchart illustrating a reserved service alarm method of a terminal according to an embodiment of the present disclosure;

FIG. 5 is a signal flow diagram illustrating a reserved service alarm method based on an electronic bill according to an embodiment of the present disclosure;

FIG. 6 is a flowchart illustrating an alarm configuration operation according to an embodiment of the present disclosure;

FIG. 7 is a flowchart illustrating an alarm execution operation according to an embodiment of the present disclosure; and

FIGS. 8, 9, 10, and 11 illustrate screen displays concerning a reserved service alarm using an electronic bill issued to a terminal according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

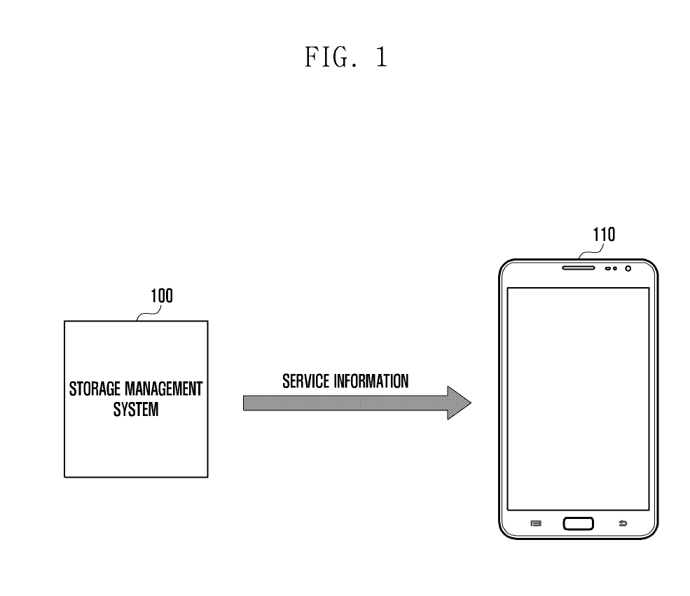

FIG. 1 is diagram illustrating service information transfer from a store management system to a terminal according to an embodiment of the present disclosure.

Referring to FIG. 1, the service provider store manages the information concerning the services using a store management system 100. The service information may include service title, store information, time information, and other supplementary informations. The store management system 100 may include a Point Of Sales (POS) system, an order processing device, such as a Near Field Communication (NFC) reader and other radio interface device, and a central server without limit thereto.

If the service is purchased or paid, the store management system 100 may transmit the service information to a terminal 110 of the customer. The service information may be transmitted by email, Short Messing Service (SMS), Multimedia Messaging Service (MMS), and NFC without limit thereto.

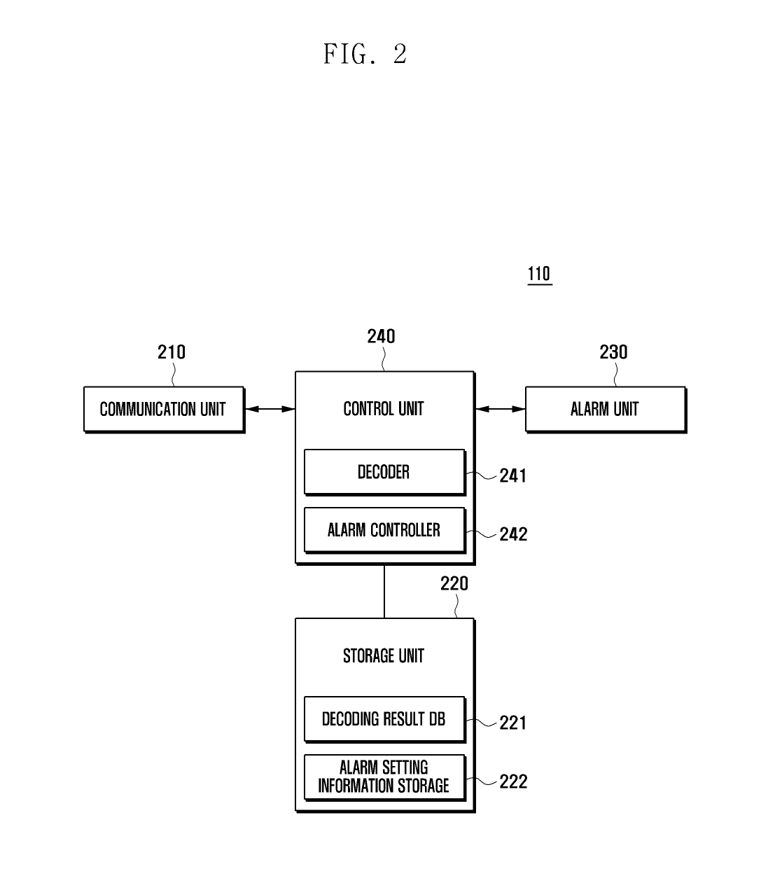

FIG. 2 is a block diagram illustrating a configuration of a terminal according to an embodiment of the present disclosure.

According to an embodiment of the present disclosure, the terminal 110 may be any of all the types of information communication devices and their equivalents capable of receiving the service information, extracting the time information from the service information, and configuring and executing an alarm based on the time information automatically.

Referring to FIG. 2, the terminal 110 includes a communication unit 210, a storage unit 220, an alarm unit 230, and a control unit 240.

The communication unit 210 is responsible for data communication/reception function of the terminal 110 and, in this embodiment, receiving the service information. The communication unit 210 may receive the service information through a network radio interface. The service information may be received in the format of the SMS message but is not limited thereto. The service information may be provided in the form of an electronic bill included in the payment information provided when the service is paid.

The storage unit 220 may store various data and application programs concerning the functional operations according to an embodiment of the present disclosure. The storage unit 220 may include a program region and a data region.

The program region stores Operating System (OS) of the terminal and application programs. The applications programs are executed selectively under the control of the control unit 240.

The data region may store the basic settings, such as ring tones and the data generated by the applications running on the terminal 110. According to an embodiment of the present disclosure, the data region may include a decoding result Database (DB) 221 for storing the decoded service information and an alarm setting information storage 222 for storing information on alarms setting information configured by the control unit 240.

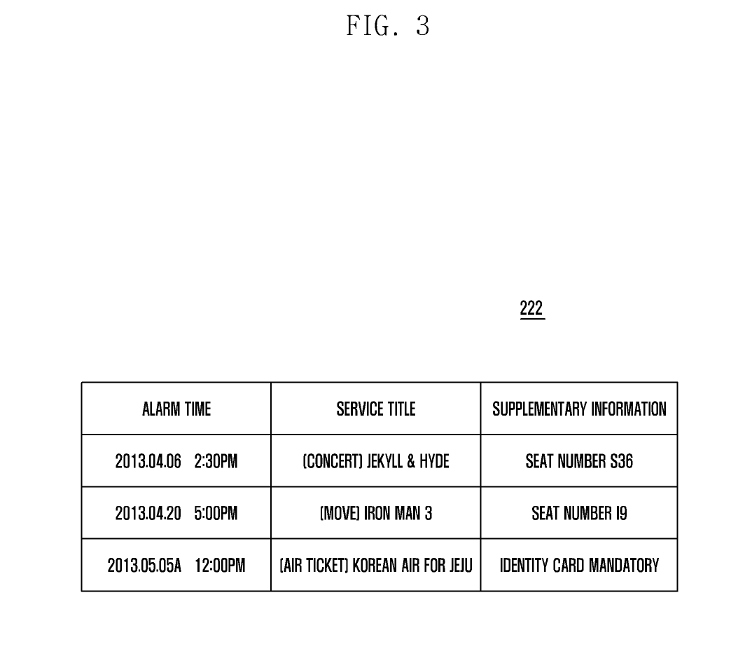

The alarm setting information storage 222 may store the alarm execution information including service title, alarm time, and other supplementary informations. For example, the alarm setting information storage 222 may store the alarm execution informations in the form of a table as shown in FIG. 3.

FIG. 3 is a diagram illustrating an alarm configuration information table stored in an alarm setting information storage according to an embodiment of the present disclosure.

Referring to FIG. 3, when an alarm time arrives, the alarm unit 230 executes the corresponding alarm stored in the alarm setting information storage 222 under the control of the control unit 240. Although not shown in the drawing, the alarm unit 230 may include at least one of a speaker and a display unit. The speaker may output an alarm sound with a ringtone, and the display unit may display an alarm message. More specifically, when the alarm time arrives, the display unit may display the service title and reserved time for the service and, if any, supplementary information.

Referring back to FIG. 2, the control unit 240 controls the overall operations of the terminal 110. In an embodiment of the present disclosure, the control unit 240 decodes the received service information to extract time information for configuring an alarm. If the configured alarm time arrives, the control unit 220 executes the alarm stored in the storage unit 220.

The control unit 240 includes a decoder 241 and an alarm controller 242.

The decoder 241 is capable of decoding the service information received, by the communication unit 210, in the form of a code. The decoding result is sorted into information items and stored in the decoding result DB 221.

The alarm controller 242 configures an alarm based on the time information item at least among the decoded information items automatically. If an alarm is set, the alarm execution is configured with an alarm time, alarm display particulars, and alarm sound. The alarm controller 242 determines the alarm time based on the time information and configures the alarm execution with the determined alarm time. If it is intended to provide the information on the corresponding service along with the execution of the alarm, the alarm execution information may further include the service information item among the decoded information items. If there is any supplementary information concerning the service, the alarm execution information may be configured so as to include the supplementary information too. The configured alarm execution information may be stored in the alarm setting information storage 222.

In the case that any concert information is decoded, the alarm setting information storage 222 may store the alarm execution information including the concert item along with the alarm time set based on the concert start time extracted from the decoding result. If the decoding result includes any supplementary information, such as seat number, the supplementary information may be included in the alarm execution information.

The alarm controller 242 may control the execution of the corresponding alarm by referencing the alarm execution information stored in the alarm setting information storage 222. More specifically, if the present alarm time arrives, the alarm controller 242 may control the alarm unit 230 to output an alarm sound and alarm message based on the alarm execution information. For example, the alarm controller 242 may control the speaker of the alarm unit 230 to output the alarm sound and control the display unit of the alarm unit 230 to display the alarm message, such as a service title and a service start time. In the case of a reserved concert alarm, when the alarm time arrives, the control unit 240 controls such that the alarm sound is executed along with the display of the concert title and concert start time. The alarm controller 242 may derive the concert start time from the alarm time. According to an embodiment of the present disclosure, the concert start time may be pre-acquired and stored in the alarm setting information storage 222 or calculated when the alarm is executed.

Although the control unit 240 is depicted in a specific configuration for explaining its operations efficiently, it will be understood by those skilled in the art that the control unit 240 in itself may executes all of the operations.

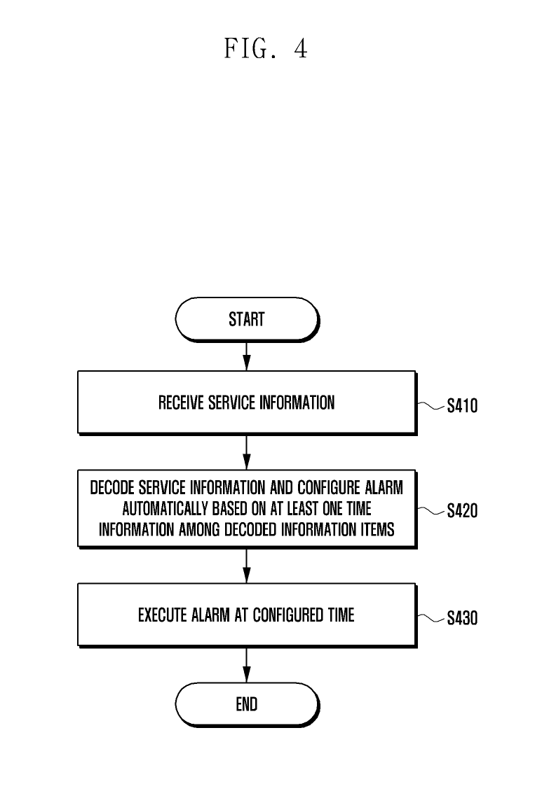

FIG. 4 is a flowchart illustrating a reserved service alarm method of a terminal according to an embodiment of the present disclosure.

Referring to FIG. 4, the communication unit 210 first receives the service information at operation S410.

The control unit 240 decodes the service information and sets an alarm based on at least the time information among the decoded information items at operation S420. The alarm is stored in the storage unit. Afterward, if the alarm time arrives, the control unit 240 controls the alarm unit 230 to execute the alarm at operation S430.

Recently, the payment information on a certain service is provided in the form of an online electronic bill instead of the paper bills to promote the service transaction. The electronic bill is an electronic document signed with an electronic signature and includes information concerning the paid service.

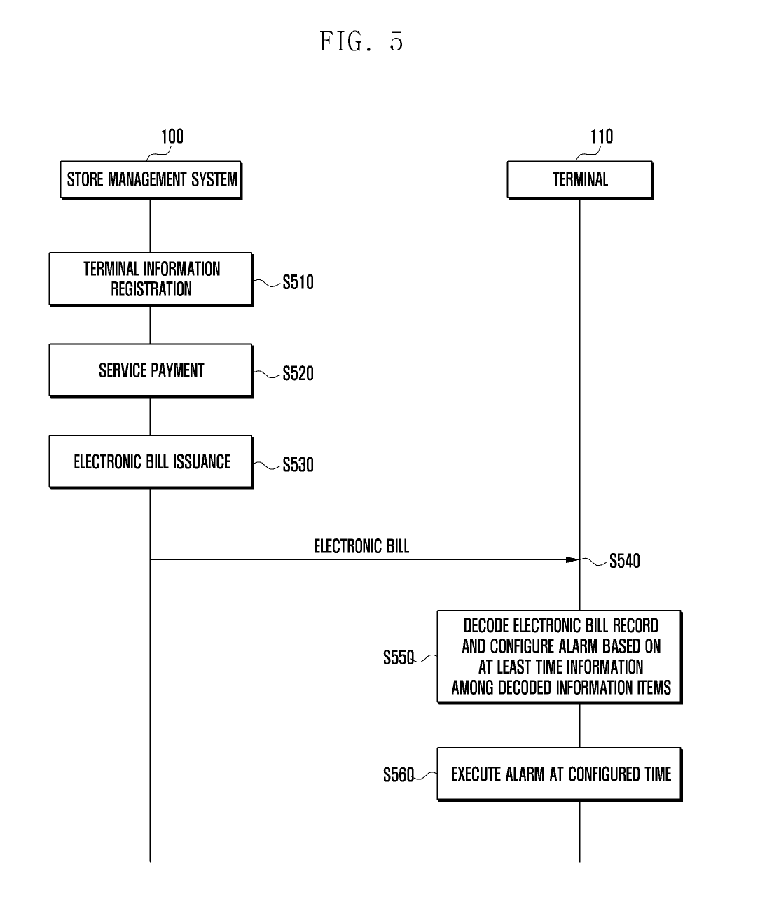

FIG. 5 is a signal flow diagram illustrating a reserved service alarm method based on an electronic bill according to an embodiment of the present disclosure.

Referring to FIG. 5, the store management system 100 first registers the information on the terminal of the service purchaser at operations S510 and processes the payment at operation S520. The service may be paid by cash, card, or NFC-enable device on the spot or using an online computer program or application.

Thereafter, the store management system 100 issues an electronic bill based on the payment information at operation S530. The electronic bill shows the payment information (including service information, such as paid service title, payment time, paid money amount, and the like) and service information (including service start time, service provision place, supplementary information, and the like).

Although the terminal information registration of operation S510 is performed before the payment for the service in the drawing, it may be performed after the payment for the service or issuance of the electronic bill.

Afterward, the store management system 100 sends the electronic bill to the corresponding terminal 100 at operation S540. At this time, the electronic bill may be transmitted by email, SMS, MMS, and NFC-enabled application through a radio interface.

If the electronic bill is received, the terminal 100 decodes the record of the electronic bill and configures an alarm based on at least the time information among the fields of the decoded records at operation S550. In an embodiment of the present disclosure, the time information is the service start time. The alarm configuration procedure is described later.

If the configure time arrives, the terminal 110 executes the alarm at operation S560. The terminal 110 executes the alarm by playing an alarm sound and displaying the service title, service start time, and supplementary information. The alarm configuration procedure is described hereinafter.

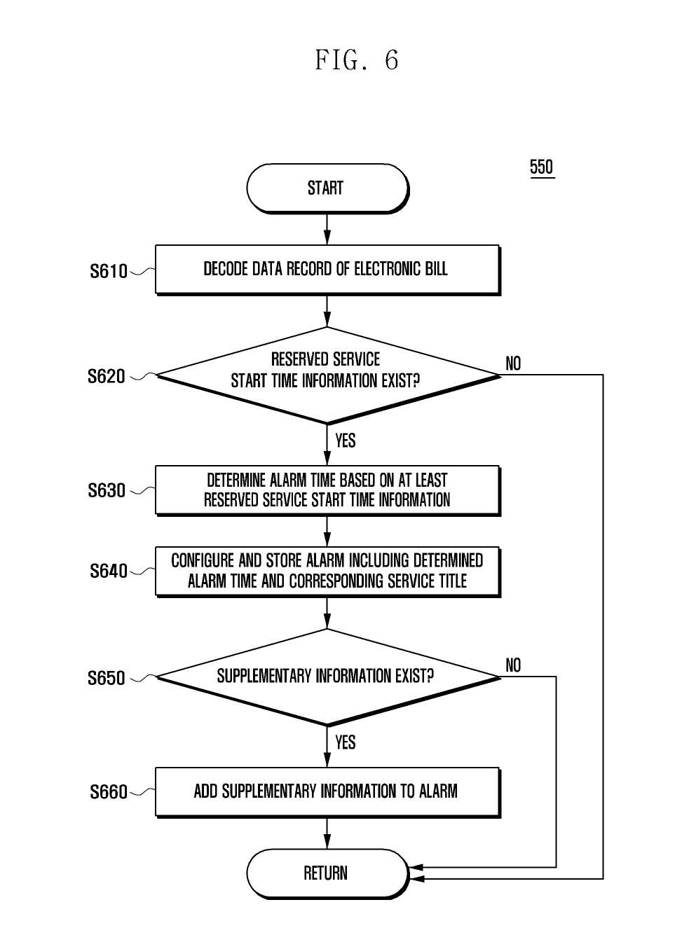

FIG. 6 is a flowchart illustrating an alarm configuration operation according to an embodiment of the present disclosure.

Referring to FIG. 6, in operation S610, the decoder 241 of the control unit 240 decodes the encoded electronic bill into a data record. Table 1 shows fields of the data record decoded from the electronic bill.

TABLE 1

| | |
|---|---|
| B1 | Transaction number |
| B2 | Store transaction processing device number |
| B3 | Paid cash amount |
| B4 | Service title |
| B5 | Provider text message (e.g., an order number, a service start time, |
| | and supplementary information) |
| B6 | Provider URL message (http://www.provider.com/event) |
| B7 | Provider issuance image (e.g., a store logo) |
| B8 | Others |

Referring to Table 1, the electronic bill includes a record of a plurality of information fields B1 to B8. The decoded fields are stored in the decoding result DB 221 of the storage unit 220.

Afterward, the alarm controller 242 of the control unit 240 determines whether the decoding result includes any time information at operation S620. The time information is the time information for alarming the user, particularly the information on the reserved service start time. If the decoding result includes no serving start time information, the alarm configuration operation ends.

If the reserved service start time information is included in the decoding result as the time information, the alarm controller 242 determines the alarm time based on the at least the reserved service start time information at operation S630. The alarm time may be identical with or different from the reserved service start time. For example, if the decoding result of reserved concert information, the alarm time may be set to the concert start time or a time point preceding the concert start time as much as time. The alarm time determination rule may be designated by the user or determined based on a value set by the alarm controller 242 without limit thereto. The alarm may be configured to activate once or repeated a number of times at a regular interval.

In another embodiment of the present disclosure, the alarm controller 242 may determine the alarm time based on the service title and the service start time. According to this embodiment, the alarm time determination rule may be determined differently depending on the service title (e.g., a service category) included in the decoding result. For example, if the type of the corresponding service is concert, the concert alarm may be configured to be activated one day before the concert, and if the type of the corresponding service is a movie, the movie alarm may be configured to be activated 2 hours before the start of the movie.

In this embodiment, the alarm controller 242 checks the service time included in the decoding result and determines the alarm time in association with the reserved service start time depending on the type of the service.

In another embodiment, the alarm controller 242 may determine the alarm time based on the corresponding service title, at least one supplementary information item, and service start time. This embodiment is applicable to the case where the service provision duration is calculated based on the service title and supplementary information. The alarm controller 242 may calculate the parking service provision duration based on the time when a car has entered the parking lot and determine the alarm time for alarming the end of the parking service based on the service end time.

If the alarm time is determined, the alarm controller 242 configures the alarm with the alarm time and the service title and storing the alarm configuration in the alarm setting information storage unit 222 at operation S640. Configuring an alarm may include configuring the alarm time, alarm display particulars, and alarm sound.

The alarm controller 242 determines whether there is further supplementary information concerning the corresponding service at operation S650. The supplementary information may include the message presented to the user when the alarm is executed. If there is any supplementary information, the supplementary information is added to the alarm execution information at operation S660.

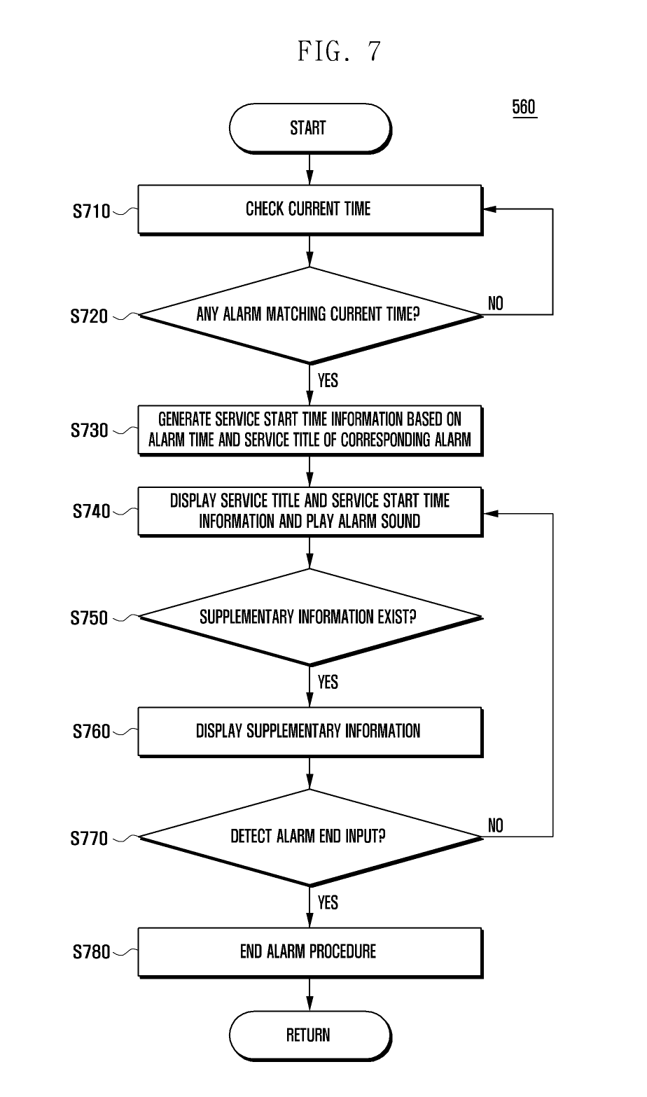

FIG. 7 is a flowchart illustrating an alarm execution operation according to an embodiment of the present disclosure. Hereinafter, the description is made in association of the operations of the terminal 110 structured as shown in FIG. 2.

Referring to FIG. 7, the alarm controller 242 checks the current time at operation S710 and determines whether there is any alarm matching the current time at operation S720. If there is no alarm set to the current time, the procedure returns to operation S710.

If there is any alarm set to the current time, the alarm controller 242 generates reserved service start time information based on the alarm time and service title of the corresponding alarm at operation S730. If the alarm time has been determined 1 day before the service start time associated with a concert service, the alarm controller 242 may generate the reserved service start time information notifying the one day before the concert. The concert start time may be generated in the form of a reserved service start time information. The reserved service time information may be generated at the time when the alarm is executed as described in the present embodiment or stored in the alarm setting information storage 222 as previously generated information.

If the service reservation time information is generated, the alarm controller 242 controls the alarm unit 230 to execute the alarm at operation S740. The alarm unit 230 plays the alarm sound and presents the service title and reserved service start time information to the user. The alarm sound may be played optionally or replaced by other alarming unit, such as a vibration.

The alarm controller 242 determines whether there is any supplementary information concerning the corresponding alarm at operation S750. If the alarm execution information includes any supplementary information, the alarm unit 230 displays the corresponding supplementary information too at operation S760.

If an alarm end request input through an input unit (not shown in FIG. 2) of the terminal 220 is detected at operation S770, the alarm controller 242 ends the alarm execution procedure at operation S780. The alarm end request may be input through various input units, such as a touch pad, a keypad, a voice recognition unit, and the like. If no alarm end request is detected, the alarm may continue or repeat at an interval. In addition, the alarm may be configured to end after being executed for a certain amount of time even though there is no alarm end input is detected.

The reserved service alarm method of the present disclosure is capable of providing the alarm about the reserved service which is configured automatically based on the information extracted from the electronic bill providing the user with the service payment information. The reserved service alarm method of the present disclosure is capable of alarming the user about the upcoming service without extra information used for configuring the alarm, resulting in improvement of user convenience.

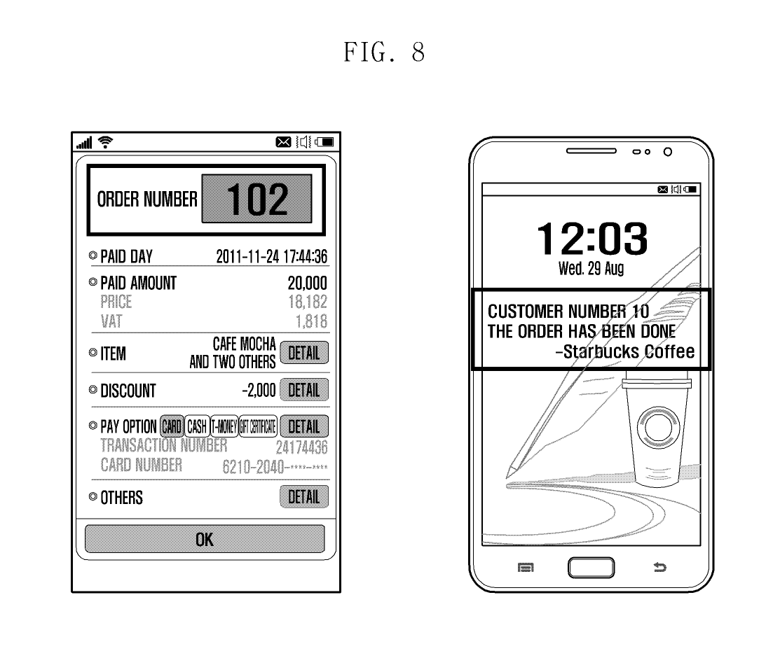

FIGS. 8, 9, 10, and 11 illustrate screen displays concerning a reserved service alarm using an electronic bill issued to a terminal according to an embodiment of the present disclosure.

FIG. 8 shows screen displays concerning a reserved service alarm method applied to a self-service coffee shop according to an embodiment of the present disclosure.

In this embodiment, the electronic bill may include the order number as the reserved service time information. The user may check the order number on the electronic bill to know his/her turn for receiving the ordered product. If the ordered product is prepared, the service provider store manager may send a push alarm to the terminal of the user through the store management system as shown in right part of FIG. 8.

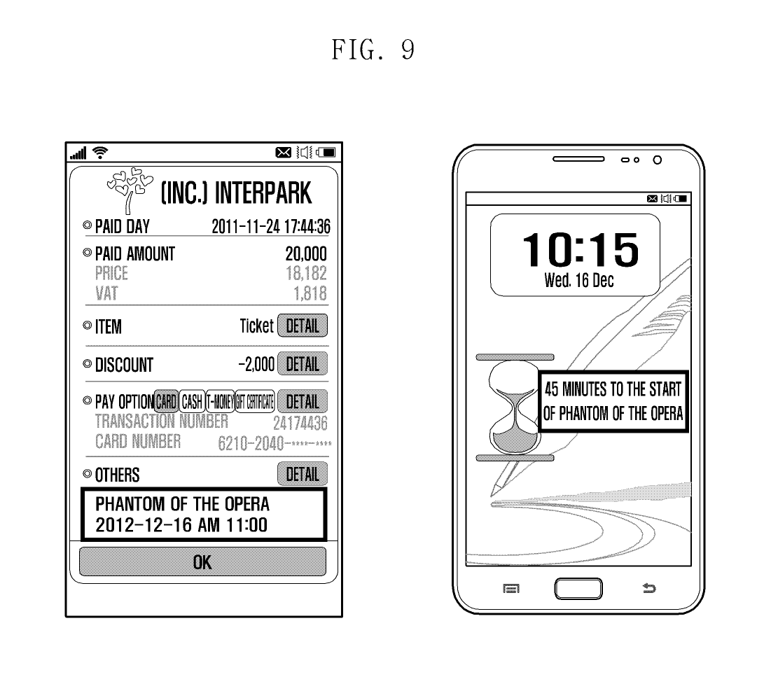

FIG. 9 shows screen displays concerning the reserved service alarm method for alarming about upcoming reserved service, such as a concert according to an embodiment of the present disclosure.

In this embodiment, the electronic bill may include the concert start time as the reserved service start time. The terminal is capable of configuring the alarm automatically based on the concert start time information extracted from the electronic bill. If the configured time arrives, the terminal executes the alarm by playing an alarm sound along with presenting the corresponding service title and concert start time to the user as shown in right part of FIG. 9.

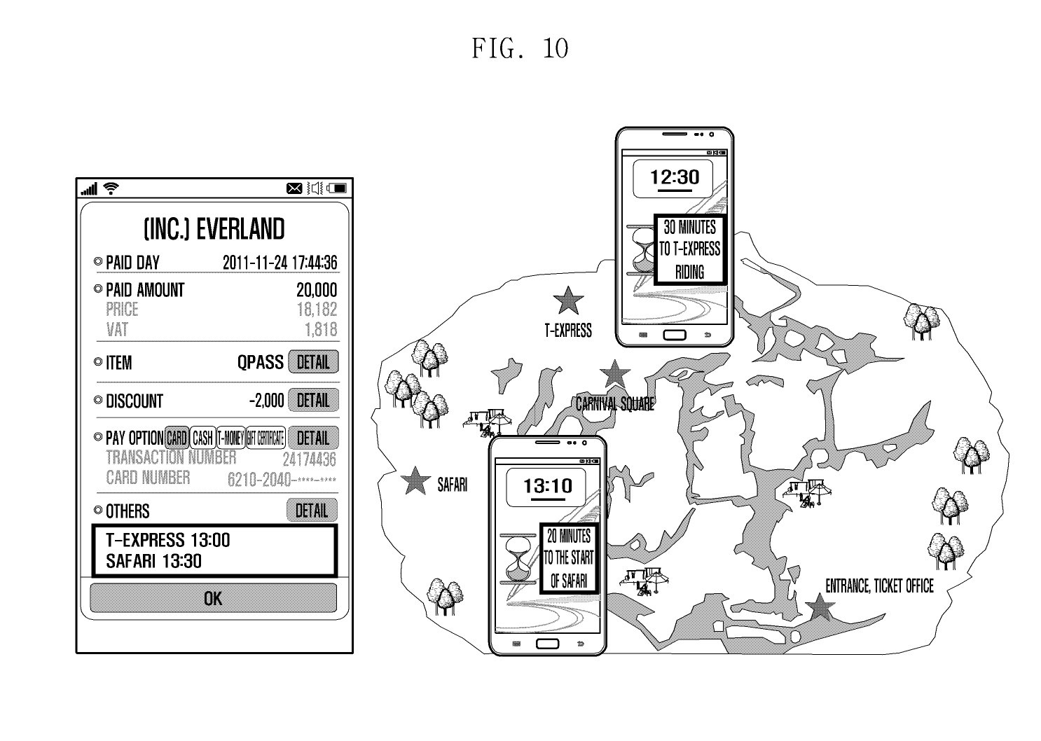

FIG. 10 shows screen displays concerning the reserved service alarm method for alarming multiple service items, such as various exciting rides of an amusement park according to an embodiment of the present disclosure.

In this embodiment, the electronic bill may include the information on the pre-paid rides as the reserved service start time. The terminal may configure a plurality of alarms automatically based on the riding time informations extracted from the electronic bill. At this time, the alarm times about the individual rides may be configured differently depending on the criteria designated by the user. When each alarm time arrives, the terminal executes the alarm by playing an alarm sound along with presenting the ride title and riding time information as shown in the right part of FIG. 10.

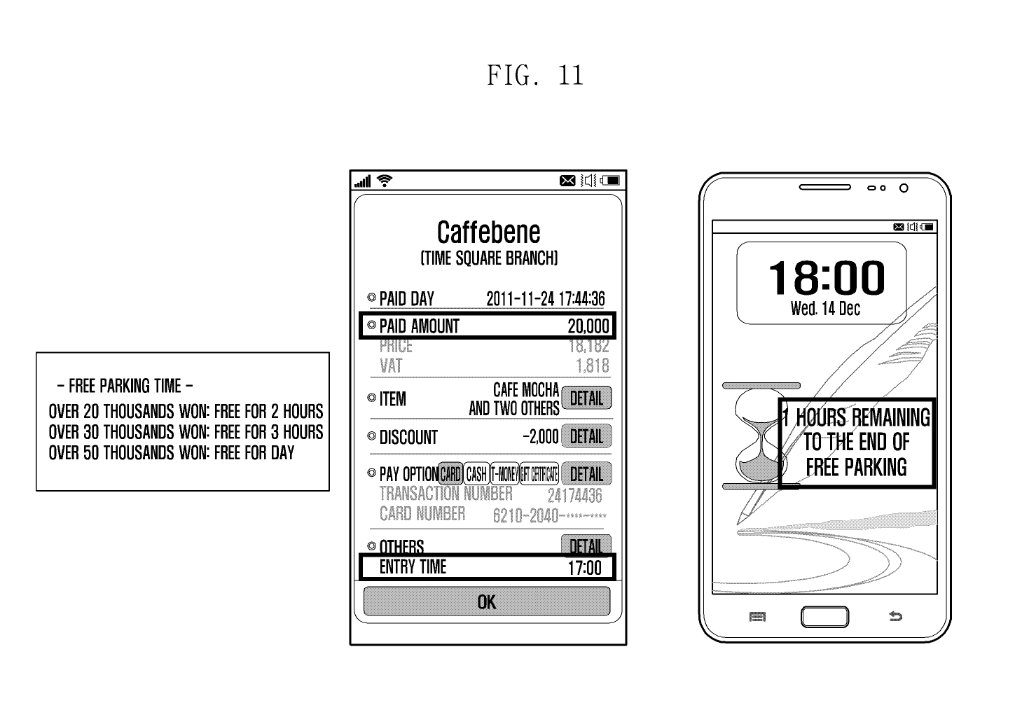

FIG. 11 shows screen displays concerning free parking service provided to the customer ordered a product in a shop, such as a coffee shop according to an embodiment of the present disclosure. In this case, the terminal determines the available service duration and alarms about the service end time.

In this embodiment, the electronic bill may include the information on the free parking service information along with the payment information. The terminal may extract the payment information from the electronic bill and calculate the free parking time based on the payment information. The free parking time is counted from the entry time provided in the electronic bill as shown in the left part of FIG. 11.

The terminal is capable of calculating the end time of the free parking service based on the entry time and the paid amount and configuring the alarm time based on the end time of the free parking service.

When the configured alarm time arrives, the terminal executes the alarm by playing an alarm sound along with presenting the available free parking time information and/or pay amount used for free parking service as shown in the right part of FIG. 11.

As described above, he reserved service alarm method and a terminal therefor is capable of alarming the user when a reserved service time arrives in order to remind the user of the upcoming reservation.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A service alarm provision method of a terminal, the service alarm provision method comprising:
receiving service information provided by a store management system;
configuring alarm execution information based on time information included in the service information; and
executing an alarm when an alarm time indicated in the alarm execution information arrives.

2. The method of claim 1, wherein the configuring of the alarm execution information comprises:
determining the alarm time based on the time information; and
generating and storing the alarm execution information including the alarm time and a service title included in the service information.

3. The method of claim 2, wherein the determining of the alarm time comprises:
checking the service title; and
determining the alarm time based on the checked service title.

4. The method of claim 2, wherein the determining the alarm time comprises:
calculating service provision period based on at least one supplementary information;
calculating service end time based on the time information and the service provision period; and
determining the alarm time based on the service end time.

5. The method of claim 4, wherein the determining of the alarm time comprises:
checking the service title; and
determining the alarm time based on the service end time according to the checked service title.

6. The method of claim 2, wherein the generating and storing of the alarm execution information comprises adding, when the service information includes supplementary information used for alarming, the supplementary information to the alarm execution information.

7. The method of claim 2, wherein the executing of the alarm comprises:
generating, when the alarm time arrives, a service start time information based on the corresponding service title and the alarm time; and
displaying the service title and service start time information.

8. The method of claim 7, wherein the displaying of the service title and service start time information comprises displaying further, when the alarm execution information includes supplementary information, the supplementary information.

9. The method of claim 1, wherein the executing of the alarm comprises ending, when an alarm end signal is input, the execution of the alarm.

10. The method of claim 1, wherein the receiving of the service information comprises receiving the service information in a form of an electronic bill, the electronic bill being an electronic document signed with an electronic signature and including service payment information.

11. A terminal comprising:
a communication unit configured to receive service information from a store management system;
a storage unit configured to store alarm execution information;
a control unit configured to configure alarm execution information based on time information included in the service information and to execute an alarm when an alarm time indicated in the alarm execution information arrives; and
an alarm unit configured to execute the alarm under the control of the control unit.

12. The terminal of claim 11, wherein the control unit is further configured to determine the alarm time based on the time information and to generate and store the alarm execution information including the alarm time and a service title included in the service information.

13. The terminal of claim 12, wherein the control unit is further configured to check the service title and to determine the alarm time based on the checked service title.

14. The terminal of claim 12, wherein the control unit is further configured to calculate service provision period based on at least one supplementary information and service end time based on the time information and the service provision period and to determine the alarm time based on the service end time.

15. The terminal of claim 14, wherein the control unit is further configured to check the service title and to determine the alarm time based on the service end time according to the checked service title.

16. The terminal of claim 12, wherein the control unit is further configured to add, when the service information includes supplementary information used for alarming, the supplementary information to the alarm execution information.

17. The terminal of claim 12, wherein the control unit is further configured to generate, when the alarm time arrives, a service start time information based on the corresponding service title and the alarm time and to display the service title and service start time information.

18. The terminal of claim 17, wherein the control unit is further configured to display, when the alarm execution information includes supplementary information, the supplementary information.

19. The terminal of claim 11, wherein the control unit is further configured to end, when an alarm end signal is input, the execution of the alarm.

20. The terminal of claim 11, wherein the communication unit is further configured to receive the service information in a form of an electronic bill, the electronic bill being an electronic document signed with an electronic signature and including service payment information.
